(19) United States
(12) Patent Application Publication
(10) Pub. No.: US 2005/0038904 A1
(43) Pub. Date: Feb. 17, 2005

(54) Data broadcast system to aid a broadcaster to transmit and receive digital information over existing audio/video broadband broadcast medium

(75) Inventor: Christopher J. Scott Dougall, Ontario (CA)

Correspondence Address: LaRiviere, Grubman & Payne, LLP, P.O. Box 3140, Monterey, CA, 93942, US

(73) Assignee: Skystream Networks, Inc., Sunnyvale, CA (US)

(21) Appl. No.: 10/946,423

(22) Filed: Sep. 21, 2004

Related U.S. Application Data
(62) Division of application No. 09/548,707, filed on Apr. 13, 2000.
(60) Provisional application No. 60/129,754, filed on Apr. 15, 1999.

(51) Int. Cl. G06F 15/16

(52) U.S. Cl. 709/236

(57) ABSTRACT

A data communication system and method that wirelessly broadcasts the full content of digital network source information to a user is accomplished by software tools that content source, schedule, and transmit and receive computer-type digital information over a broadband broadcast medium. The data communication system is independent of any broadcast hardware, and can be used to schedule the broadcast of many different services, such as standard files, web sites, program guide and rotating files, by IP-Multicast, RS422, RS232, and TCP/IP communications capable of broadcasting via conduits that comprise television VBI, radio subcarrier, satellite (DSS,DVB), MPEG-2, paging networks, telephone networks, local area networks, and the Internet at the same time. The file contents are sent in pieces (or packets) to a broadcaster hardware in a data stream, that are formatted for being reconstructed into files by the client receiver.

### CROSS-REFERENCE TO RELATED APPLICATIONS

This patent application claims the benefit of U.S. Provisional Patent Application Ser. No. 60/129,754, entitled: DATA BROADCAST SYSTEM TO AID A BROADCASTER TO TRANSMIT AND RECEIVE DIGITAL INFORMATION OVER EXISTING AUDIO/VIDEO BROADBAND BROADCAST MEDIUM, filed Apr. 15, 1999, by the same applicant.

### FIELD OF THE INVENTION

The present invention relates to broadcast systems that include transmission of digital information with existing audio/video broadcasts. More particularly, the present invention relates to broadcast systems that include transmission of digital information with existing audio/video broadcasts by utilizing software tools that source, schedule, and transmit and receive computer-type digital information over a broadband broadcast medium.

### BACKGROUND OF THE INVENTION

The need to provide information to the public continues to challenge the information provider and has created numerous industries that includes radio, and television industry to present day Internet provider of on-line services utilizing telephone lines to carry the signals that contain the information. Accordingly, information is provided to the public utilizing wireless communication technology, or by utilizing wired (cable) communications technology for providing the on-line services. The Internet, no doubt, via the World Wide Web (WWW), is a major source of information for the public. Although the personal computer has been an excellent tool to use as a means that facilitates getting information to individuals, the digital form of the information content used by the personal computer devices has been limited to utilization of on-line services via modem devices.

The audio/video industry, utilizing wireless broadcast technology, provides a excellent way of communicating information to the public. However, in present day working environments, traditional audio/video equipment are not provided as part of the work-place tools. If the audio/video equipment is provided, it is provided for entertainment purposes. The broadcast signals utilized by audio/video equipment do not include the digital signal information, such as the digital signal information transmitted by on-line services. Computer devices, on the other hand, have included audio/video peripheral equipment as part of the computer hardware multi-media componentry, and include digital signal receiving means for converting the on-line audio/video digital signal transmissions into audible and viewable information.

The need for systems that combine the benefits of multimedia, wireless and wired on-line services has been recognized in U.S. Pat. No. 6,021,433 to Payne et al. The Payne et al. patent teaches a data communication system that connects on-line networks with on-line and off-line computers and broadcasts the notification centric portions (headlines) of available network information. A computer user receives notification that there is an incoming message concerning the headlines. The Payne et al. patent further teaches that wirelessly broadcasted URLs, in the form of headline containing data packets, are provided for being used to obtain detailed data. While, the '433 patent has provided a data communication system for delivering network source headline messages utilizing wireless broadcasting, narrowcasting, and pointcasting, a need is seen for a data communication system and method that wirelessly broadcasts the full content of the network source information, not merely notification about the content that requires further action by the user to retrieve the details of the information.

Accordingly, a primary object of the present invention is to provide a data communication system and method that wirelessly broadcasts the full content of digital network source information to a user.

### SUMMARY OF THE INVENTION

The foregoing primary object of providing a data communication system and method that wirelessly broadcasts the full content of digital network source information to a user is accomplished by software tools that content source, schedule, and transmit and receive computer-type digital information over a broadband broadcast medium. The data communication system of the present invention, commercially known as Jetstream, and marketed by Skystream Corporation of Thunder Bay, Ontario, Canada (formerly known as Varuna Software Inc.) has a TCP/IP based communications layer that enables the suite of applications to be run across a local or wide area network. This layer also enables the system to be scaled to any size of operation, from one computer, to a large network of computers. The software tools comprise a server/head end, herein referred to as the Jetstream Server/Head End (Suite), a client/end user end, herein referred to as Jetstream Client/End, and a data stream format, herein referred to as Jetstream Stream Format. The Jetstream Server Suite is a group of integrated software applications, designed and tested to run on a personal computer operating system, such as the commercially available Microsoft Windows NT 4.0 operating system. This set of server end applications is used to facilitate the scheduled gathering and transmitting of the full content of digital information from a source, such as the WWW network source. The present invention comprises the following modules:

Server/Head End

An application program, herein referred to as JetWeb, used for retrieving Internet information, and storing it locally.
An application module, herein referred to as JetQueue Module, used for transmitting scheduled services, that supports IP-Multicast, RS422, RS232, and TCP/IP communications, capable of broadcasting via conduits that comprise television, VBI, radio subcarrier, satellite (DSS,DVB), MPEG-2, paging networks, telephone networks, local area networks, the Internet.
An application module, herein referred to as Control Center, used to schedule tasks for the external modules, all other modules can be remotely controlled from the command center, allowing centralized organization of tasks and services.
An application program, herein referred to as JetMonitor, resident on all Jetstream systems, utilized to issue and respond remote commands and report on the status to remote modules.
   Client/End User End
An application program, herein referred to as Jetstream Client, for decoding and receiving the full content broadcast data that makes the full content information available to a computer desktop by storing files, caching web sites, and opening streams (sockets).
An application program, herein referred to as Jetstream Program Guide, used by the user to select which services to receive, or to view the schedule of incoming services, and to look at a catalog of what has been received, it also contains a rotating information (advertising) banner.
   The data communication system of the present invention, utilizes an industry standard ODBC database (supports MSAccess, Informix, SQLServer, Intrabase, ORACLE, etc.) for centralized scheduling and storage of data on a computer hard disk media. This allows the data to be integrated into the existing back office of the customer easily and efficiently. The data communication system of the present invention is designed to be independent of any broadcast hardware, and can be used to schedule the broadcast of many different services, such as standard files, web sites, program guide and rotating files, over many different media at the same time. The service files are sourced by a module source (Fetched) which in turn transmits the files to a broadcaster's hardware. The file contents are sent in pieces (or packets) by Jetqueue to a broadcaster hardware in a data stream, herein referred to as Jetstream Packet, which are formatted in a format, herein referred to as Jetstream Stream Format. The Jetstream Packet also comprises header information. By example, a web site service type is sourced by a sourced module, herein termed JetWeb Module, which establishes a connection to the specific web site, downloads the web sites files (similar to a Web Browser), parses the received HTML, looking for any referenced element and fetches this as well. The website service files are packetized and then sent to the broadcaster's hardware as determined by JetQueue Module, for being received by a client.

Other features of the present invention are disclosed or are apparent in the section entitled, “DETAILED DESCRIPTION OF THE INVENTION.”

### BRIEF DESCRIPTION OF DRAWINGS

For a better understanding of the present invention, reference is made to the accompanying drawings wherein:

FIG. 1.0 is a block diagram representation of the content-based data communication system of the present invention, illustrating a server/head end, a broadband broadcasting system and a client/end user end.

FIG. 2.0 is a flow diagram illustrating a content-based packet construction process in accordance with the present invention.

FIG. 3.0 is a diagram representation of a content-based packet, illustrating header byte and data byte allocations, in accordance with the present invention.

FIG. 4.0 is a block diagram illustrating a server/head end object hierarchy for server operation in accordance with the present invention.

FIG. 5.0 is a block diagram representation of the server/head end JetQueue Control Center, illustrating interaction of selected system components, such as the Jetserver window, for monitoring and controlling transmission of scheduled content-based digital data communication services.

FIG. 6.0 is an exemplary JetQueue Control Center computer display window of Queue Properties illustrating general status information about transmission of scheduled services, in accordance with the present invention.

FIG. 7.0 is an exemplary client/end computer display window illustrating a program guide inventory of available services, herein referred to as Jetstream Program guide, in accordance with the present invention.

FIG. 8.0 is an exemplary client/end computer display window illustrating a program guide inventory and status of subscribed services, herein referred to as Jetstream Program guide, in accordance with the present invention.

FIG. 9.0 is an exemplary client/end computer display window illustrating on/off control of a broadcast receiver for receiving services, herein referred to as Jetstream Broadcast Receiver, in accordance with the present invention.

FIG. 10.0 is an exemplary client/end computer display window illustrating an on-status of the on/off broadcast receiver services feature, including a pop-up window about viewing other options, herein referred to as Jetstream Broadcast Receiver. in accordance with the present invention.

FIG. 11.0 is an exemplary client/end computer display window illustrating an a view of statistics of broadcasted receiver services as selected from a pop-up window shown in FIG. 10.0, herein referred to as Jetstream Statistics, in accordance with the present invention.

### DETAILED DESCRIPTION OF THE INVENTION

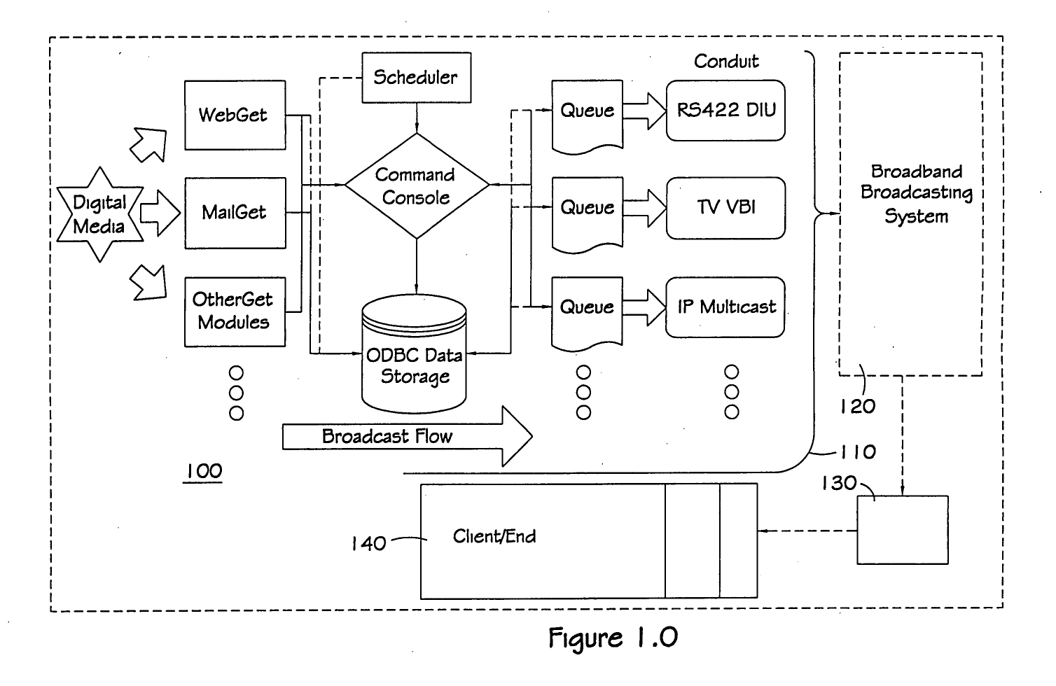

FIG. 1.0 shows an overview representation of the content-based data communication system (Jetstream) 100 in accordance with the present invention. As illustrated, content-based data communication system 100 comprises a server/head end 110, a broadband broadcasting system 120 and a client/end user end 130/140. Jetstream 100 is a data broadcast system and to that end server/head end 110 facilitates a broadcaster to add transmission of digital information to their existing audio/video broadcast. Server/head end 110, and a client/end user end 130/140 comprise software tools that source, schedule and receive the digital information transmitted by the broadcaster.

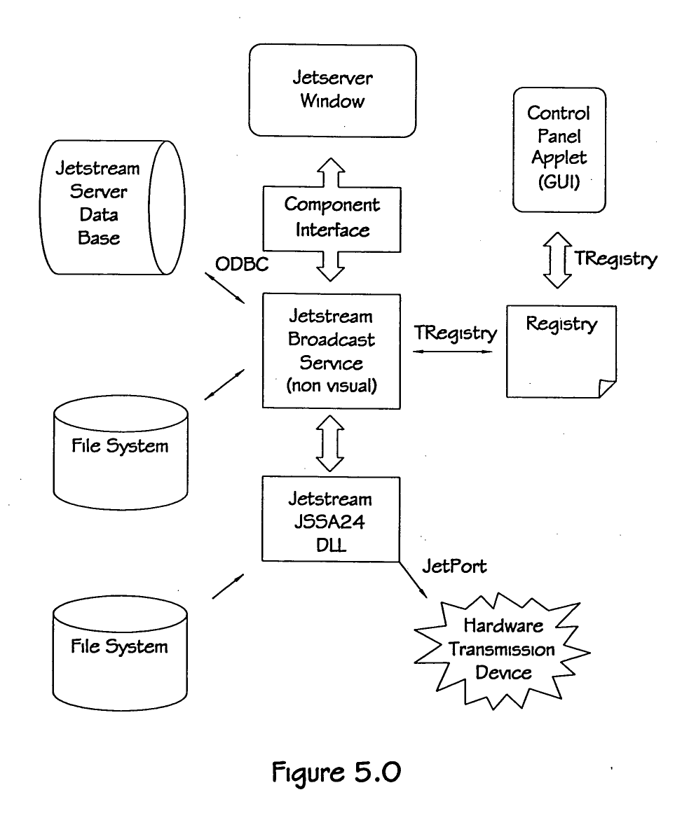

The Jetstream 100 software tools are based on the concepts of services, modules and jobs. Services are defined as a logical grouping of computer files, modules are defined as a program that performs a specific task to the files of a service, and jobs control timing of when a module performs its assigned task. Services include by example, a standard file, which are an unrelated grouping of files, a web site service which are files that make up a WWW site, program guide services, which are files used to update the client program guide listing and rotational file services, which are unspecific related grouping of files. A broadcaster decides what services to create and transmit. Modules include fetch modules transmit modules, and combination fetch and transmit. Fetch modules, include webget, also referred to as Jetweb, and are utilized for updating the files within a service to add/delete/modify files see generally FIG. 1.0. Fetch modules also includes modules such as getmail, also shown in FIG. 1.0. Transmit modules are modules such as JetQueue, that forward all files within a service to the broadcaster hardware designed to perform the actual signal broadcast to clients. JetQueue is the main transmit module, see generally FIG. 5.0. Combination fetch/transmit modules include JetControl module and JetMonitor module. JetControl is a control center module that performs fetch operations on standard files and rotational file services. JetMonitor does not perform any task on a file service, but is used to start and stop modules in a distributed environment. Table 1.0 table breaks down by service type which module sources (fetches) the services files, and which module transmits them to the broadcaster specific hardware.

TABLE 1.0
Service Type/Module Relationship

| | Service files are | Service files are |
|---|---|---|
| Service type | controlled by | transmitted by |
| standard file | control center | JetQueue |
| web site | JetWeb | JetQueue |
| program guide | JetQueue | JetQueue |
| rotational file | Control Center | JetQueue |

Jobs control when a module performs its assigned task to a service. Jobs are scheduled to run at a specific time and date. They are assigned to a service and a module. Jobs may be either a single job or a repeat job. A single job is scheduled to run once at a specific date/time. A repeat job is scheduled to run at a specific date/time, and to re-schedule itself to run again at a later date/time. By example, a repeat job may be schedule to repeat every two (2) hours. Table 2.0 breaks down by service type and module what happens upon running a service/module pair.

TABLE 2.0
Service type/Module Pair Run Results

| Service type | JetWeb Module | JetQueue Module |
|---|---|---|
| Standard file | n/a | Send all files in the |
| | | service to the |
| | | broadcaster's hardware. |
| Web site | Establish a connection to | Send all files in the |
| | the specific Web site, | service to the |
| | download the sites files (same | broadcaster's hardware. |
| | as a Web Browser does) | |
| | parse the received HTML, | |
| | looking for any referenced | |
| | element, then fetch those | |
| | elements as well. Repeat sa | |
| | per setting of Web services. | |
| Program Guide | n/a | Create a file that contains |
| | | all information regarding |
| | | available services, and |
| | | send it to the |
| | | broadcaster's hardware. |
| Rotational File | n/a | Select one (only one) file |
| | | from the service and send |
| | | it to the broadcaster's |
| | | hardware. |

At the Client/end user end the software tools comprise two main applications with several support tools. The main client application tools are JetStream Broadcast Receiver, which listens for incoming streams of data sent by JetQueue, and JetStream Program Guide which provides a GUI to client operations, manages service subscriptions, displays broadcast schedules and displays active operations from the receiver. The broadcast Receiver runs continually in the background, displaying a small glyph in the icon tray. The Program Guide can be started and started at will and does not need to be operating for signal reception.

JetStream 100 works by breaking the full content of the files into smaller pieces (packets) adding some header information to each packet and sending the file packets to the client. The client/end user software reassembles the packets into the original files. The core of all JetStream broadcasts is the broadcasted JetStream Packets, which contain the full content of the digital data information from the services discussed above and which distinguish the present invention from other related teachings, such as U.S. Pat. No. 6,021,433 to Payne et al. The following Table 3.0 describes a JetStream packet in accordance with the present invention.

TABLE 3.0
JetStream Packet

| | |
|---|---|
| Stream Number | Multiple Jobs can be active on JetQueue at one time, |
| | Stream Number determines for the client which |
| | job this packet is from. |
| Packet Number | Within a stream, each packet is numbered, so the client |
| | can determine if any packets have been lost during |
| | transmission, a common occurrence. |
| Packet size | the size of the data block |
| Content | (see Table 4.0) |
| Data | Data is interpreted based on content |
| Sync Byte | a special byte indicating the end of the packet |

The following Table 4.0 breaks down Content vs. Data within a JetStream Packet.

TABLE 4.0
Packet Content vs. data

| Content Value is | Then Data portion of Packet Contains |
|---|---|
| JS_JobBegin | Details of a new job starting, its service code, |
| | job name, etc |
| JS_EntryBegin | Details of a new file starting, file name, URL |
| | data, expected size |
| JS_EntryData | actual file contents |
| JS_EntryEnd | indicator that the current file entry has been completed |
| JS_JobEnd | indicator that the current job has completed |

Table 5.0 shows as an example a job run for a standard file service. The standard file includes three files that are less than 1 Kbytes (file1.txt, file2.txt, and file3.txt). JetQueue begins a job run on the standard service and sends the packets to the client.

TABLE 5.0
Example of sending a packet sequence

| Packet Sequence is: (a JetStream packet | |
|---|---|
| is created on this content) | Signifies to the Client |
| JS_JobBegin (with unique Stream | Transmission of the file |
| Number) | service has begun on this |
| | Stream Number |
| JS_EntryBegin (beginning send of | Open for reception file1.ext |
| file1.ext ) | |
| JS_EntryData (contents of file1.ext) | save data block to file1.ext |
| JS_EntryEnd (end of send for file1.ext) | close file1.ext |
| JS_EntryBegin (beginning send of | Open for reception file2.ext |
| file2.ext.) | |
| JS_EntryData (contents of file2.ext.) | save data block to file2.ext |
| JS_EntryEnd (end of send for file2.ext.) | close file2.ext |
| JS_EntryBegin (beginning send of | Open for reception file3.ext |
| file3.ext.) | |
| JS_EntryData (contents of file3.ext.) | save data block to file3.ext |
| JS_EntryEnd (end of send for file3.ext.) | close file3.ext |
| JS_JobEnd (completion of job on this | all files received for this |
| Stream Number) | service |

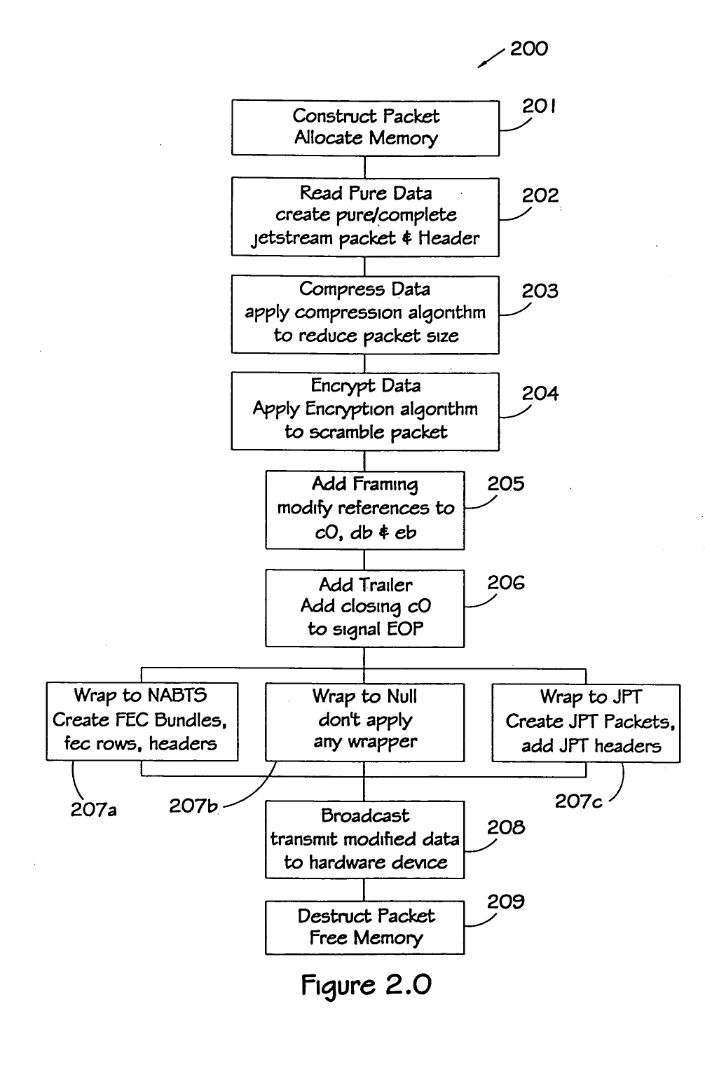

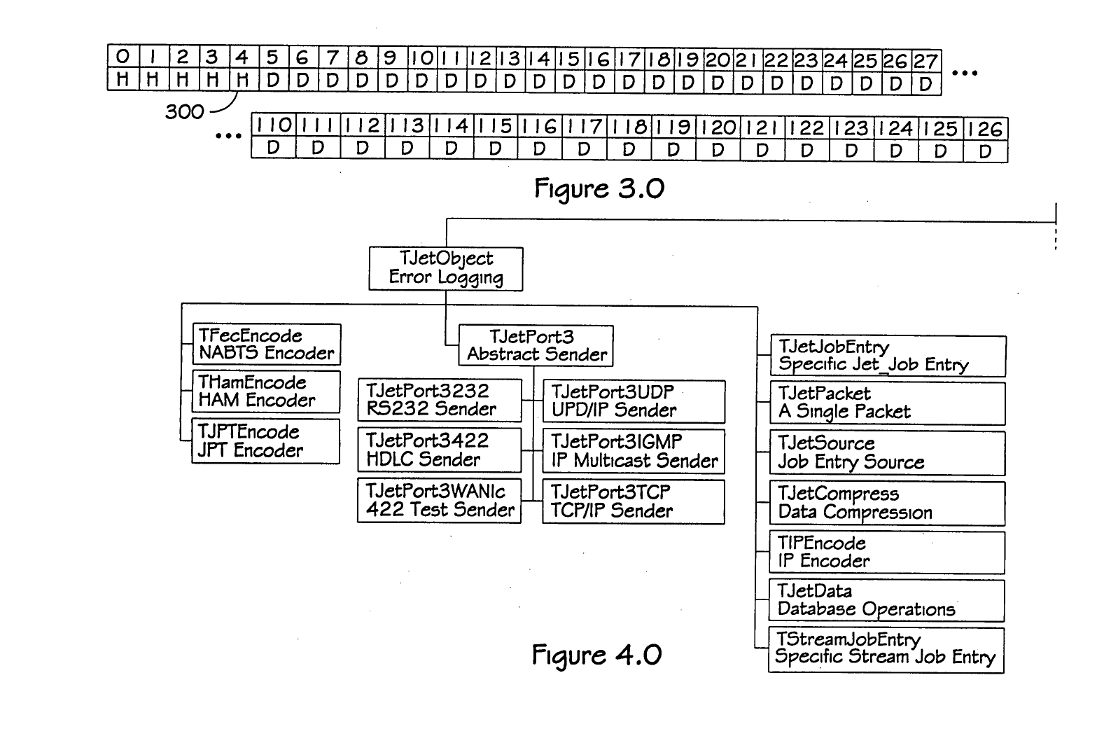

FIG. 2.0 shows a process 200 for breaking down files into packets generally shown as packet 300 in FIG. 3.0. The packet construction process 200 begins a step 201 where memory is allocated in a data storage, such as an ODBC data storage unit member of Server/Head end 110. The contents of the file are read (not created) at step 202. The file data is then compressed at step 203 using a compression algorithm to reduce the packet size. The compressed data is then encrypted at step 204 using an encryption algorithm to scramble the packet. Framing is then performed on the encrypted packet at step 205. A trailer is added at step 206 to signal an end of packet (EOP). The desired wrapping is then added at steps 207a, 207b, and 207c, where step 207a denotes a Wrap to NABTS (creates the forward error correction (FEC) bundles, fec rows and header), step 207b denotes Wrap to Null (no wrapper), and 207c denotes Wrap to JPT (JetStream Packet Transport which are portions of a complete JetStream packet, and adds headers). The modified content file is then transmitted to broadcast hardware at step 208 and then the packet is destroyed at step 209 to restore/free-up memory in the storage unit member. FIG. 3.0 shows packet 300 as being 127 bytes long, where bytes 0-4 are allocated for header H information and bytes 5-126 are allocated to data. Table 6.0 shows additional details of the packet format of the present invention.

TABLE 6.0
JetStream Packet Format Details

| Byte # | Description | Details |
|---|---|---|
| 0, 1, 2 | Packet | 3 hamming perfect bytes. Indicates start of a JPT |
| | Address | Packet and each byte must be from 0-15 |
| | | (i.e. 242) |
| 3 | Continuity | 1 hamming perfect byte. Indicates portions of |
| | Index | entire JetStream packet this portion os from. |
| | | Starts at 0, ends when content flag indicates EOP. |
| | | (wraps from 15 to 0 as required) |
| 4 | Content Flag | 1 hamming perfect byte, bitmask indicating |
| | | bit 0-full/filled packet* (padding added?) |
| | | bit-1-last JetStream packet chunk |
| | | bit 2, 3-Future Fec/CRC details? |
| 5-126 | Data Chunk | Clear portion of JetStream packet |

(*Note:
Filler data is added as required to the end of the packet. First added character is OxEA then as many 0x15′s as needed to complete the 127 byte JTP packet size.)

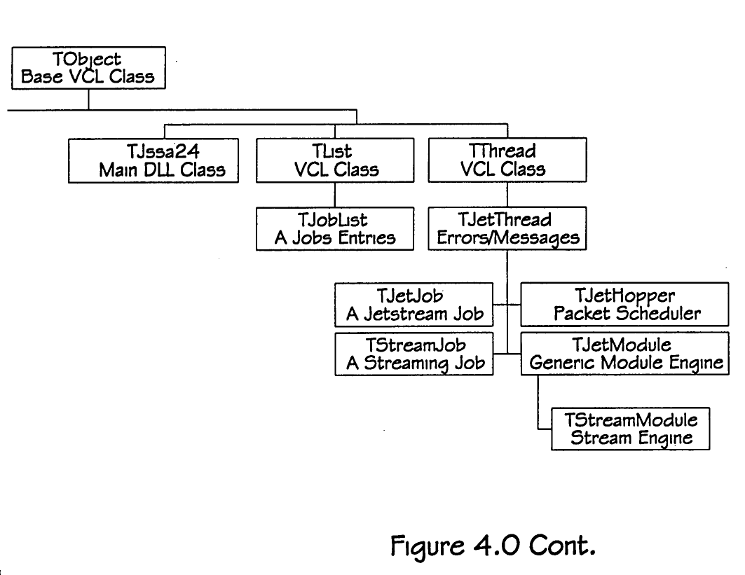

FIG. 4.0 is a block diagram illustrating a server/head end object hierarchy for server operation in accordance with the present invention. This hierarchy assures encapsulation of all server operations into and out of the database.

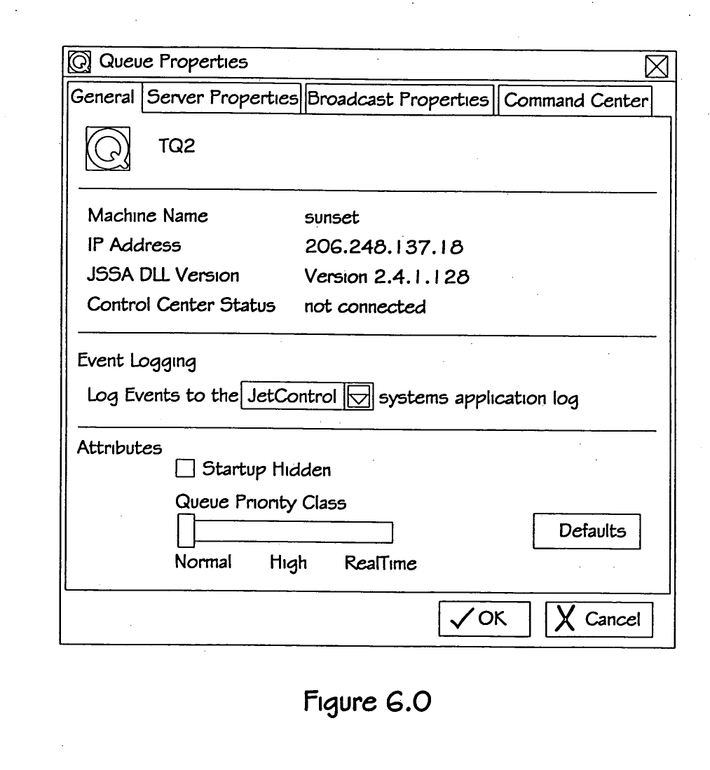

FIG. 5 illustrates the JetQueue Module that is used for transmitting scheduled services, that supports IP-Multicast. RS422, RS232, and TCP/IP communications, that are capable of broadcasting via conduits, as illustrated in FIG. 1.0, that comprise television, VBI, radio subcarrier, satellite (DSS,DVB), MPEG-2, paging networks, telephone networks, local area networks, the Internet to a Client/User end 130/140. The two components of JetQueue are the control Center Midi Window (JetServer WIndow) and the broadcast service to drive the DLL (JetStream Broadcast Service) to a hardware transmission device. In one embodiment of the present invention Internet Protocol (IP) is used to move data to a wireless gateway, termed DBN. FIG. 6.0 shows a computer display window showing the queue (JetQueue) general properties. From this window the server properties are configured. By example configure the route from the queue to an inserter device (serial Rs232, UDP/IP, TCP/IP, etc). The transmission rate in bits per second can also be specified from this window. The broadcast format can also be configured form this window. For example, for satellite (DVB) transmit JetStream with no wrapper. Packet compression can be enabled or disabled.

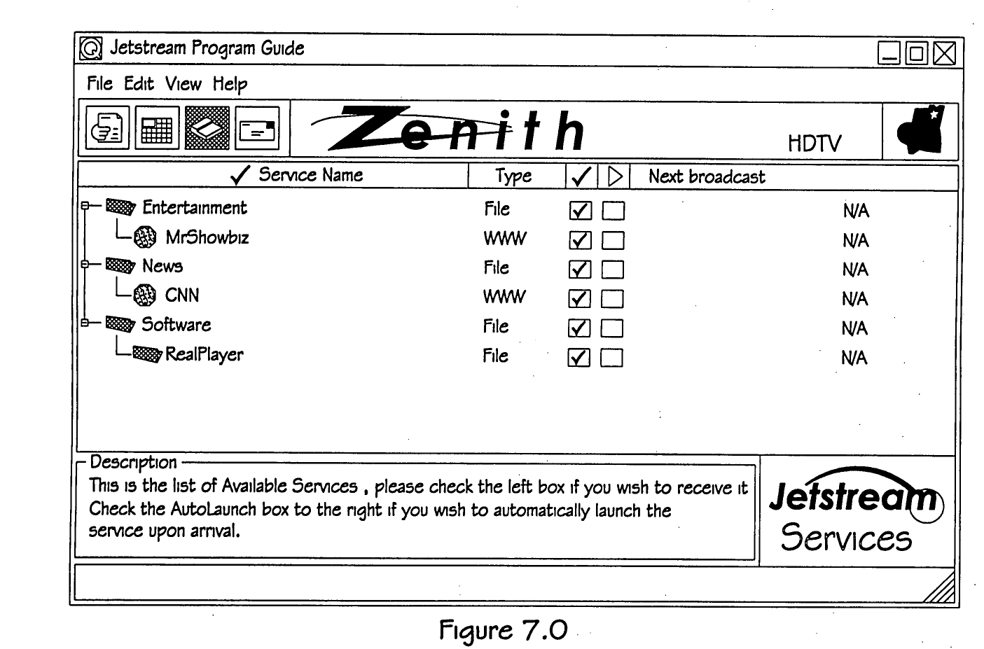

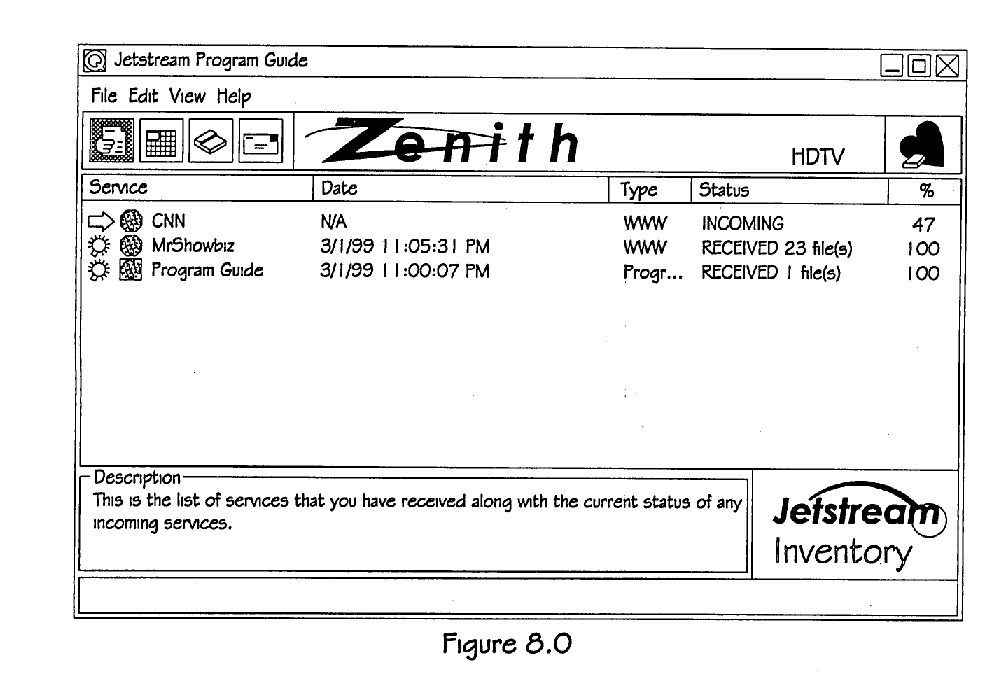

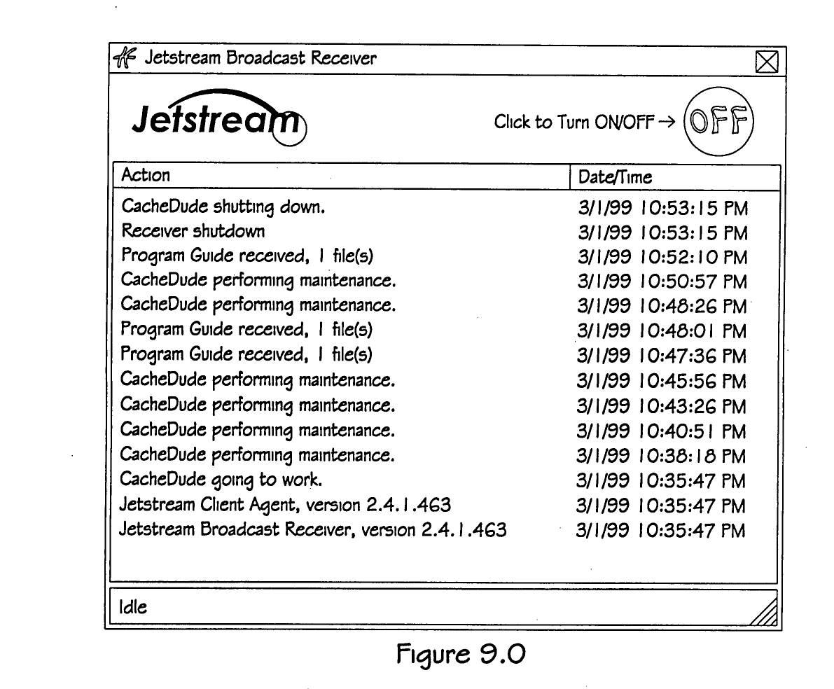

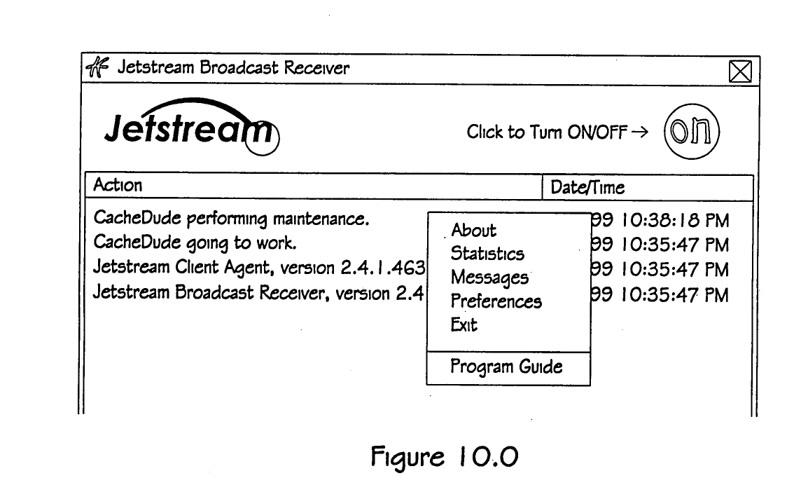

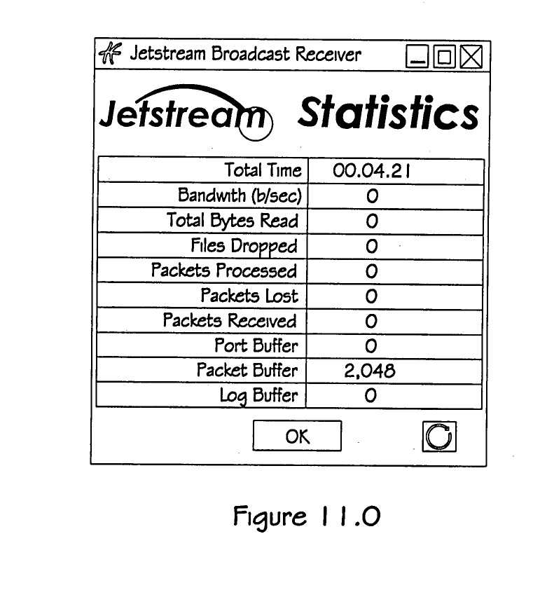

The client receivers are populated via a Program Guide that contains information about the services available, and which allows a user to elect to receive or ignore the content. The content is saved as files in the storage unit of a user's computer, or is cached into a web browser for publishing the information in the users Program guide. FIG. 7.0 shows an exemplary client/end computer display window illustrating a program guide inventory of available services. The program guide originates at the server/head end, at the control center and may include a default set of services which are made available to a user. Similarly, a user may select a file service, the file service is created and filled with the requested files and included as a job in the program guide. A web site service would have to be fetched and transmitted and handled in a similar fashion by the program guide. FIG. 8.0 is an exemplary client/end computer display window illustrating a program guide inventory and status of subscribed services. FIG. 9.0 is an exemplary client/end computer display window illustrating on/off control of a broadcast receiver for receiving services. FIG. 10.0 is an exemplary client/end computer display window illustrating an on-status of the on/off broadcast receiver services feature, including a pop-up window about viewing other options, such as statistics. FIG. 11.0 is an exemplary client/end computer display window illustrating an a view of statistics of broadcasted receiver services as selected from a pop-up window shown in FIG. 10.0.

The present invention has been particularly shown and described with respect to a certain preferred embodiments and features thereof. However, it should be readily apparent to those of ordinary skill in the art that various changes and modifications in form, material, and design detail may be made without departing from the spirit and scope of the inventions as set forth in the appended claims.

1. A broadcast system, said broadcast system comprising:
a server-end means for scheduling, gathering and transmitting an entire digital database content of at least one type of digital information service, said server-end means having means for encoding said full-digital data content for being broadcasted; and
a client-end means for decoding and receiving the broadcasted full-digital database content and providing the full informational content of said at least one type of digital information services.

2. A broadcast system as described in claim 1, wherein:
said server-end means further comprises communication means for facilitating transmission of said entire digital database content via IP-Multicast, RS422, RS232, and TCP/IP type of communications links for further broadcasting via conduits selected from a group of conduits that comprise television VBI, radio subcarrier, satellite (DSS,DVB), MPEG-2, paging networks, telephone networks, local area networks, and the Internet.

3. A broadcast system as described in claim 1, wherein:
said means for encoding comprises a packet construction means for breaking up an original digital file into smaller digital file pieces and transmits said smaller digital file pieces as a stream of packets; and
wherein said client-end means comprises broadcast data receiving means for re-assembling said stream of packets into said original file.

4. A broadcast system as described in claim 1, wherein:
said server-end means further comprises means for retrieving and storing an entire digital informational content of a selected electronic network site.

5. A broadcast system as described in claim 1, wherein:
said server-end means further comprises a means for providing a program guide of services for use by a user, said program guide facilitating means for selecting which services to receive, means for viewing the schedule of incoming services, and means for reviewing a catalog of what services have been received, said program guide means further providing a rotating information banner.

6. A contents-based digital data broadcast system, said system comprising:
a first server-end application program means for retrieving a first type of digital information, and storing a entire contents of said digital information locally;
a first server-end application module means for encoding, transmitting scheduled services including said entire contents of said digital information, said first application module comprising means for supporting IP-Multicast, RS422, RS232, and TCP/IP communications and means for broadcasting said encoded entire contents of said digital information via conduits that comprise television, VBI, radio subcarrier, satellite (DSS,DVB), MPEG-2, paging networks, telephone networks, local area networks, and the Internet;
a second server-end application module means for scheduling tasks for external modules; facilitating centralized organization of tasks and services provided to a client;
a second server-end application program means for issuing and responding to remote commands and reporting on a status of a task to remote modules;
a first client-end application program means for decoding and receiving the full content of said broadcasted encoded digital information; and
a second client end application program guide means for facilitating selection of which service to receive, viewing a schedule of incoming services, and review of a catalog of what services have been received, said program guide means further providing a rotating information banner.

7. A method for wirelessly transmitting digital information with existing audio/video broadcasts, said method comprising the steps of:
(a) providing a server-end means for scheduling, gathering, and transmitting an entire digital database content of at least one type of digital information service, said server-end means having means for encoding said full-digital data content for being broadcasted;
providing a client-end means for decoding and receiving the broadcasted full-digital database content and providing the full informational content of said at least one type of digital information services; and
wirelessly transmitting said full digital database content at said client-end means for being manipulated and being used by a subscriber of said digital information services.

8. A method for wirelessly transmitting digital information, as described in claim 7, wherein said means for encoding comprises breaking down files into at least one packet of digital information:
(a) allocating memory in a data storage unit member of said server-end means;
(b) reading data contents of a file;
(c) compressing the read file data;
(d) encrypting the compressed data;
(e) framing the encrypted packet; and
(f) adding an end of packet (EOP) indication to said at least one packet.

9. A method for wirelessly transmitting digital information, as described in claim 8, wherein said method further comprises the steps of:
(g) wrapping said packet with additional information selected from wrapping options comprising a Wrap to NABTS (creates the forward error correction (FEC) bundles, fec rows and header), a Wrap to Null (no wrapper), and a Wrap to JPT (JetStream Packet Transport which are portions of a complete jetstream packet, and adds headers); and
(h) destroying an encoded packet after being wirelessly transmitted, said encoded packet being destroyed for purposes of freeing-up memory in the storage unit member.
